(19) United States
(12) Patent Application Publication
(10) Pub. No.: US 2024/0252941 A1
(43) Pub. Date: Aug. 1, 2024

(54) BUILD-YOUR-OWN CUSTOMIZABLE SLIME PROCESS

(71) Applicant: Oozapalooza Inc, Las Vegas, NV (US)

(72) Inventor: Tasiona Hill, Las Vegas, NV (US)

(21) Appl. No.: 18/424,208

(22) Filed: Jan. 26, 2024

Related U.S. Application Data
(60) Provisional application No. 63/481,972, filed on Jan. 27, 2023.

(51) Int. Cl. A63H 9/00

(52) U.S. Cl. CPC A63H 9/00

(57) ABSTRACT

The disclosure provides a method of making a personalized slime product including the steps of identifying a type of slime to be made; selecting a glue base; selecting a color to dye the glue base; mixing the color and the glue base; the customer adding slime foam beads, shaving cream, or slime activator to the mixed color and glue base and mixing together; applying slime activator to the customer's hands; the customer poking the slime against a surface using the individual's fingertips; and the individual kneading the slime to the desired consistency to form a personalized slime product.

### CROSS-REFERENCE TO RELATED APPLICATIONS

This application claims priority to U.S. provisional application No. 63/481,972 filed on Jan. 27, 2023 which is herein incorporated by reference in its entirety.

### BACKGROUND

### Technical Field of the Invention

The invention is directed to a build-your-own customizable slime process from beginning to end optionally with the help of a slime instructor.

### Description of the Related Art

Slime products are popular among children. Slime products are a non-toxic, viscous, material made from guar gum. Making a slime product at home is a messy process and it usually takes several trials before a child can get the right mixtures for a good quality Slime.

The present invention is a Slime making process for a commercial or retail setting that eliminates the problems and shortcomings of making slime at home. Currently available Slime products and slime kits, where all the ingredients are pre-measured, do not result in a high-quality slime product and the child may waste a lot of time and money. Also importantly, the available methods do not provide an interactive experience that can be obtained in a commercial or retail setting. The present invention overcomes these problems by providing an interactive slime making product process, where a customer can obtain all the ingredients and mix and make a Slime product in an interactive environment optionally with the assistance of in-store slime product assistants providing support.

Currently available Slime toys are prefabricated Slime making kits, where all the ingredients are pre-measured, and all the ingredients are mixed according to a specified slime making procedure. The motivation behind the inventive process is to create a place where people can go for retail and entertainment while crafting slime. The invention is a process that solves the problem of consumers inability to craft a usable slime independently by providing a hands-on, step-by-step process and instruction during the slime crafting process. The invention thus provides a process for making a slime product that eliminates the shortcomings of currently available slime making kits.

### SUMMARY OF THE INVENTION

The disclosure relates to a method of making a personalized slime product in a retail setting by a customer including the steps the customer identifying a type of slime to be made; the customer selecting a glue base; the customer selecting a color to dye the glue base; the customer mixing the color and the glue base; the customer adding slime foam beads, shaving cream, or slime activator to the mixed color and glue base and mixing together; applying slime activator to the customer's hands; the customer poking the slime against a surface using the individual's fingertips; and the individual kneading the slime to the desired consistency to form a personalized slime product.

In another embodiment, a To-Go Slime Bar includes handcrafted pre-made slimes for retail sale. The customer orders a themed slime from a slime bar menu. A sales associate prepares the slime bar product and then packages it for a customer to take to go.

### BRIEF DESCRIPTION OF THE DRAWINGS

FIG. 1 shows: display wall and order of crafting; customers remain seated while the instructor offers crafting materials from each section of the display wall; the display wall includes sections of Glue Base; Paint Color; Foam Bead Add-ins; Activator; Slime Type; Add-ins; charms, glitter, scent; and Container/Packaging.

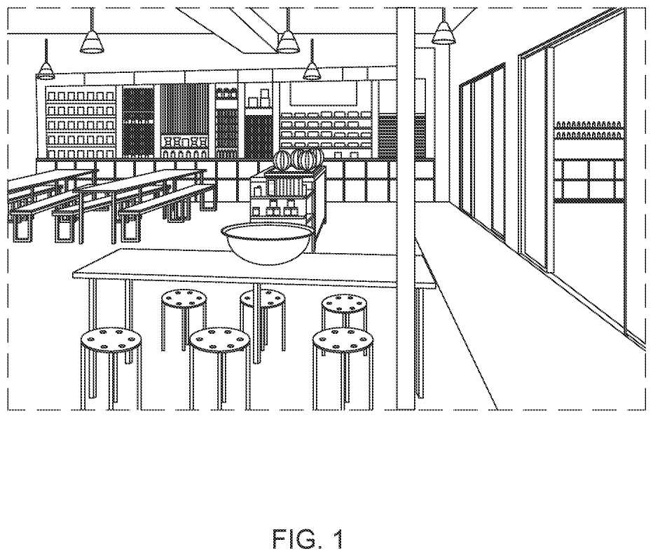

FIG. 2 shows a Pre-Made Slime to-go Bar; customers can order a handmade slime to take to-go; the customer places the order from the items on the menu; the salesperson prepares the slime order to-go. The design consists of slime in an ice cream cabinet, which is scooped to order and topped with slime add-ins, packaged, bagged, and sold to-go.

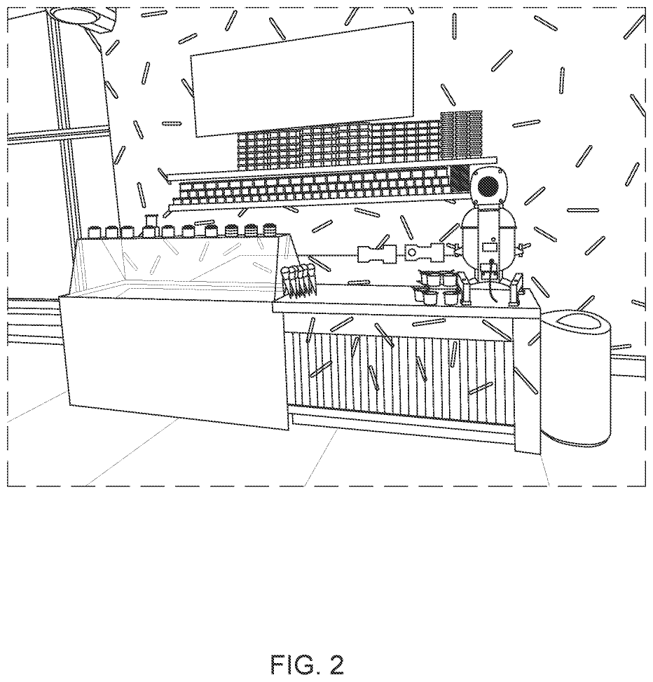

FIG. 3 shows scooping slime from the to-go bar ice cream cabinet.

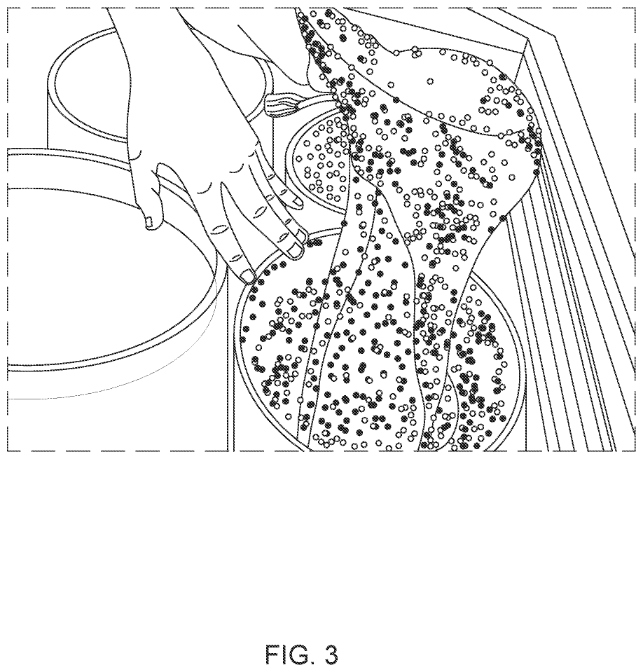

FIG. 4 shows a flow chart illustrating steps of the invention.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products and/or systems described herein. However, various changes, modifications, and equivalents of the methods, products, and/or systems described herein will be apparent to an ordinary skilled artisan.

### Modes for Carrying out the Invention

An exemplary process of the invention may include the steps described below.

The process may begin with a customer and instructor identifying a type of slime the customer wishes to craft. Once the slime type is selected, the customer is walked through a slime crafting process step-by-step and provided hands on assistance from an instructor. The first step in this process is the glue base. Glue is given to the customer and poured or squeezed from the glue bottle into the customer's crafting bowl. Next, the customer selects a color of paint or food coloring to dye the glue, changing it from clear or white into the color of the customer's preference. The customer is instructed to mix the color and the glue together until these parts can no longer be separated or viewed independent of each other.

The customer is then provided slime foam beads, shaving cream, or slime activator as the next step in the crafting process dependent on which type of slime the customer chooses to make at the beginning of the process. With the instructor's optional guidance, the customer adds one or all of these items to the dyed glue mixture and vigorously mixes together. The instructor may go through several rounds of activating the slime until its preferred texture and consistency is reached. The instructor then removes the slime from the bowl and places it onto the table. The instructor applies activator to the customers hands and instructs the customer to rub their hands together to coat the hands completely. The instructor tells the customer to poke their slime against the table using their fingertips as the initial steps to touch and knead their slime.

After poking is completed satisfactorily, the instructor instructs the customer to pick their slime up from the table and kneed it using a stretch and fold method. As kneading is performed, the instructor checks the slime consistency for appropriateness, and adds more activator or lotion as needed. If the customer chooses to craft a butter slime or cloud slime at the beginning of their session, the instructor will add clay or artificial snow to the slime in the desired amount to achieve the preferred texture.

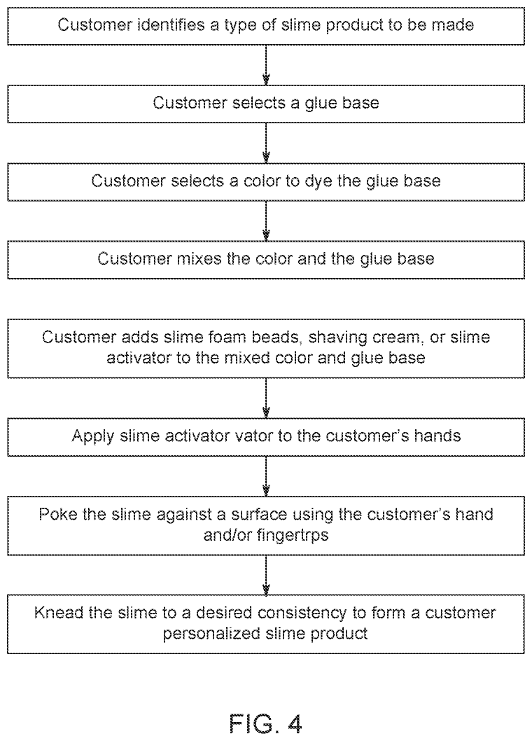

FIG. 4 shows a flow chart illustrating the steps of the inventive method. Generally speaking, the steps of the method can be done in any order and are not necessarily limited to the sequence shown in FIG. 4.

In embodiments, nevertheless, the steps are performed in the sequence shown in FIG. 4. In embodiments, the method comprises the steps shown in FIG. 4. For example, as discussed above, additional steps can be performed, such as adding more activator or lotion or adding clay, artificial snow, etc., to achieve a given final texture. In embodiments, nevertheless, the method can consist of or consist essentially of the steps shown in FIG. 4. Furthermore, the method can consist of or consist essentially of the steps shown in FIG. 4 in the order shown in FIG. 4.

The process is a build-your-own customizable slime from beginning to end with the optional help of a slime instructor. Customers can dress their slime with different add-ons which include glitter, slime charms, slime scents, slime sprinkles and clay pieces.

In another embodiment, a To-Go Slime Bar includes handcrafted pre-made slimes for retail sale. The customer orders a themed slime from a slime bar menu. A sales associate prepares the slime bar product and then packages it for a customer to take to go.

In one embodiment, the to go slime bar may be an ice cream to go slime bar. A customer first orders an ice cream themed slime from the slime bar menu. The sales associate then scoops the slime from the ice cream cabinet. The sales associate then constructs it to the desired consistency adding activator, lotion, clay, foam beads, scent, glitter, sprinkles, and/or artificial snow as needed.

The process thus begins with a customer ordering a type of ice cream slime from a slime bar menu. Once the slime product is selected, the sales associate scoops the slime from the ice cream cabinet. The sales associate then selects a glue base. Next, the sales associate selects a color of paint or food coloring to dye the glue, changing it from clear or white into the color of the ice cream desired. The color and the glue are mixed together until these parts can no longer be separated or viewed independent of each other. Slime foam beads, shaving cream, or slime activator are added as the next step dependent on which type of ice cream slime the customer ordered and vigorously mixed together. Several rounds of activating the slime may be performed until its preferred texture and consistency is reached. The instructor then applies activator and kneads and/or pokes the slime to the desired consistency. More activator or lotion can be added as needed. The sales associate then packages the ice cream slime product for a customer to take to go. This process can be performed in the sequence described above. In embodiments, the method comprises the steps discussed above and may include further steps. For example, as discussed above, additional steps can be performed, such as adding more activator or lotion or adding clay, etc., to achieve a given final texture. In embodiments, nevertheless, the above method can consist of or consist essentially of the steps above. Furthermore, the method can consist of or consist essentially of the steps above performed in the order given above.

A materials List may include: glue (white and clear), glow in the dark paint, glow in the dark glue, borax, Sta-Flo; water; modeling clay, Styrofoam beads, fishbowl beads, clay slime pieces, acrylic charm, plastic charm, Glitter, Artificial Snow, Plastic Sprinkles, Fragrance Oil, Food Coloring, Acrylic Paint, Shaving Cream, and Lotion.

There is a 3-tier concept. First, interactive retail and entertainment retail is provided where the customer has the ability to create a personalized slime for retail. In tier 1, slime crafting sessions with an individual instructor/host for a specified amount of time are provided. The slime craft sessions, birthday parties, and events follow a crafting process where the host/instructor begins by providing the customer with the initial materials required to craft. These materials include, but are not limited to an apron, bowl, spatula, etc.

Once the customer is ready to begin, the instructor goes over the slime menu and pricing. The customer orders their slime types and slime items from the options provided. The instructor begins the slime crafting process with the customer using the items specific to their order. Throughout the session, the instructor is following a step-by-step slime crafting method that takes glue through the chemical process of becoming the slime.

The method is designed to accurately craft the customer's customized slime and to provide a slime entertainment experience. The instructor entertains the customer throughout the crafting session by doing slime tricks and providing slime education. There are multiple crafting steps that the instructor follows in order to ensure that the appropriate slime is crafted with each customer. These steps start with the glue base, then color, foam add-ins, activator and specialty type, charms selection, scent selection, and packaging. Some steps can be completed in various order.

The facility offers services that are designed for customers with varying time restraints. In tier 2, Customers in 5-7 minutes can order a pre-made slime from the Pre-made Slime Scoop Bar which includes gallons of slime that are already crafted, they are scooped out of the ice cream cabinet using an ice cream scooper, stretched/kneaded, packaged, then topped with slime toppings such as sprinkles, beads, foam, clay, glitter, and charms. In tier 3, customers are able to host a slime crafting birthday party in a facility. The parties follow the same process as the session for a longer duration and a larger number of guests.

The disclosed methods can be deployed in a variety of environments including in a conventional store environment such as a shopping mall or in a kiosk or in any other retail setting.

### Glossary

Slime as used herein is a non-toxic, viscous, squishy, usually colored material made primarily from guar gum. The composition can include polysaccharide guar gum and sodium tetraborate, other alcohol-group containing polymers (such as polyvinyl alcohol) may be used as alternatives to the polysaccharide.

Glue as referred to herein generally refers to multipurpose glues or white glues which are typically PVA-based synthetic glues. Elmer's Glue™, and the like, would be examples.

Dyes as referred to herein generally refer to dyes, pigments, or substances that impart color when added to the slime. Typical dyes would include food coloring dyes. Dyes may be natural (e.g., anthocyanins and cochineal) or artificial/synthetic (e.g., tartrazine yellow). Dyes can include, for example, plant pigments such as carotenoids, chlorophyllin, anthocyanins, and betanin.

Slime activators, as used herein, can generally refer to compositions such as borax powder, saline solution, starch or liquid starch, baking soda (sodium bicarbonate), and boric acid. Other compositions commonly known and used as slime activators are also contemplated.

Foam beads, shaving cream, glitter, slime charms, slime scents, slime sprinkles and clay pieces are items and compositions well known and are used herein consistent with their ordinary meaning and usage in the art.

A commercial or retail setting as contemplated herein generally refers to a shop or store, for example, such as those normally found in a shopping mall, or a kiosk as also found in shopping malls or similar environments.

While this disclosure includes specific examples, it will be apparent after an understanding of the disclosure of this application has been attained that various changes in form and details may be made in these examples without departing from the spirit and scope of the claims and their equivalents.

1. A method of making a personalized slime product in a retail setting by a customer comprising:
the customer identifying a type of slime to be made;
the customer selecting a glue base;
the customer selecting a color to dye the glue base;
the customer mixing the color and the glue base;
the customer adding slime foam beads, shaving cream, or slime activator to the mixed color and glue base and mixing together;
applying slime activator to the customer's hands;
the customer poking the slime against a surface using the individual's fingertips; and
the individual kneading the slime to the desired consistency to form a personalized slime product.

2. The method of making a personalized slime product of claim 1, wherein the personalized slime product is a butter slime or a cloud slime and further includes the step of adding clay or artificial snow to the slime product to form the personalized slime product.

3. The method of making a personalized slime product of claim 1, further including dressing the personalized slime product with one or more of: glitter, slime charms, slime scents, slime sprinkles or clay pieces.

4. A method of making a handcrafted ice cream slime from a To-Go Slime Bar including:
selecting a type of ice cream slime from a slime bar menu;
scooping an ice cream slime;
selecting a glue base;
selecting a color of paint or food coloring to dye the glue;
mixing the color and the glue together until these parts can no longer be separated or viewed independent of each other;
adding slime foam beads, shaving cream, or slime activator dependent on which type of ice cream slime the customer ordered and vigorously mixing;
applying activator, kneading and/or poking the slime to a desired consistency;
packaging the ice cream slime product.
